(19) United States
(12) Patent Application Publication
(10) Pub. No.: US 2005/0094198 A1
(43) Pub. Date: May 5, 2005

(54) Server apparatus, network system and data transmission/reception control method

(75) Inventor: Yasushi Ishizuka, Hamura-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA.

(21) Appl. No.: 10/958,601

(22) Filed: Oct. 6, 2004

(30) Foreign Application Priority Data
Oct. 31, 2003 (JP) 2003-373622

(51) Int. Cl. G06F 15/00; G06F 15/16

(52) U.S. Cl. 358/1.15; 709/203

(57) ABSTRACT

A client-client data transmission/reception control unit checks the storage location of data requested by a client apparatus by use of a data management list. If the data is stored in a different client apparatus, whether a function of directly transmitting/receiving data is supported by the two client apparatuses is checked by use of client apparatus information. If the function is supported by both of the client apparatuses, the client-client data transmission/reception control unit issues an instruction to the two client apparatuses to make data transmission/reception between the concerned client apparatuses without passing through a server apparatus.

### CROSS-REFERENCE TO RELATED APPLICATIONS

This application is based upon and claims the benefit of priority from prior Japanese Patent Application No. 2003-373622, filed Oct. 31, 2003, the entire contents of which are incorporated herein by reference.

### BACKGROUND OF THE INVENTION

1. Field of the Invention

The present invention relates to the data transmission/reception control technique in a home network system or the like to which a plurality of domestic electric appliances are connected, for example.

2. Description of the Related Art

In recent years, electronic apparatuses which are called home servers start to be widely used in families. The home server has a function of receiving and recording a television broadcast and a function of transmitting data of the received and recorded television broadcast by radio. Therefore, the user can enjoy the television broadcast in a desired place by use of, for example, a personal computer with the radio communication function.

Further, some of the home servers have not only a function of receiving and recording a television broadcast but also a function of relaying AV data from various types of audio/visual (AV) players to a personal computer of the user or the like. According to the above home server, the user can enjoy contents of a CD or DVD set in the AV player in a desired place. A network configured by mainly using the home servers is called a home network system.

When the user of the home server enjoys the contents of the AV player by using his own personal computer, data transmission from the AV player to the personal computer is carried out by performing two communications containing data transmission from the AV player to the home server and data transmission from the home server to the personal computer in practice. Thus, the condition is not very favorable as the utilization condition of a finite radio band.

Based on the above condition, recently, a network system which permits direct data transmission and reception between electronic apparatuses such as AV players and personal computers used as client apparatuses as viewed from the home server is proposed (for example, refer to a pamphlet of International Patent Disclosure No. 01/057678). According to this type of network system, the load of the server apparatus is alleviated and the radio band can be effectively used.

The method disclosed in the pamphlet of International Patent Disclosure No. 01/057678 is to determine whether or not transmission/reception of data to be transmitted/received between the client apparatuses is placed under the control of the server apparatus according to the attributes of data and directly transmit/receive data which is determined different from data to be controlled between the client apparatuses. The server apparatus has nothing to do with transmission/reception of data which is determined different from data to be controlled and data transmission/reception is freely made between the client apparatuses concerned. Therefore, if the amount of data to be transmitted/received between the client apparatuses increases, the service condition in the radio band becomes worse. However, since the data transmission/reception is different from that controlled by the server apparatus, nothing can be done to control the data transmission/reception. On the other hand, all of data that is determined to be placed under control is uniformly transmitted/received via the server. That is, data is not directly and stably transmitted/received between the client apparatuses under the control of the server apparatuses by use of the method disclosed in the pamphlet of International Patent Disclosure No. 01/057678.

### BRIEF SUMMARY OF THE INVENTION

According to an embodiment of the present invention, a server apparatus comprises a data management unit configured to manage information associated with data held by a first client apparatus; a device management unit configured to manage information indicating whether data can be directly transmitted/received between the first client apparatus and a second client apparatus; a determination unit configured to determine whether data requested by the second client apparatus is held in the first client apparatus based on the information managed by the data management unit, and determine whether data can be directly transmitted/received between the first and second client apparatuses based on the information managed by the device management unit; and a control unit configured to control the first and second client apparatuses to directly transmit/receive data when the determination unit determines that the first client apparatus holds the requested data and the data can be directly transmitted/received.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing an example of the configuration of a network system according to an embodiment of this invention;

FIG. 2 is a view showing a concrete example of the network system of the present embodiment;

FIG. 3 is a diagram showing function blocks of a server apparatus in the present embodiment;

FIG. 4 is a diagram showing an example of the contents of a data management list held in the server apparatus in the present embodiment;

FIG. 5 is a diagram showing an example of the contents of client apparatus information held in the server apparatus in the present embodiment;

FIG. 6 is a diagram showing function blocks of a client apparatus in the present embodiment;

FIG. 7 is a flowchart showing a flow of the process at the starting time of data transmission/reception between the client apparatuses on the server apparatus side in the present embodiment;

FIG. 8 is a flowchart showing a flow of the process at the starting time of data transmission/reception between the client apparatuses on the client apparatus side in the present embodiment;

FIGS. 9A and 9B are diagrams showing the state of normal data transmission/reception between the client apparatuses via the server apparatus in the present embodiment;

FIGS. 10A and 10B are diagrams showing the state of direct data transmission/reception between the client apparatuses without passing through the server apparatus in the present embodiment;

FIG. 11 is a diagram showing a concrete example of a case wherein direct data transmission/reception cannot be made between two client apparatuses depending on the positional relation;

FIG. 12 is a flowchart showing a flow of a data transmission/reception switching process on the server apparatus side in the present embodiment; and

FIG. 13 is a flowchart showing a flow of a data transmission/reception switching process on the client apparatus side in the present embodiment.

### DETAILED DESCRIPTION OF THE INVENTION

There will now be described an embodiment of this invention with reference to the accompanying drawings.

FIG. 1 is a diagram showing an example of the configuration of a network system according to an embodiment of this invention. As shown in FIG. 1, the network system includes one server apparatus 1 and a plurality of client apparatuses 2 connected to the server apparatus 1 via radio or wire. In the example of FIG. 1, the client apparatus (3) 2 is connected to the server apparatus 1 by wire and the other client apparatuses (1), (2), (4), (5) 2 are connected to the server apparatus 1 by radio. The server apparatus 1 manages the storage location of data held by the respective client apparatuses 2 in addition to data held by the server apparatus 1. If the server apparatus 1 itself holds data requested by any one of the client apparatuses 2, the server apparatus 1 transmits the data therefrom. If data requested by the client apparatus 2 is held by a different one of the client apparatuses 2, the server apparatus 1 controls the two client apparatuses 2 to permit the client apparatus 2 which holds the data to transfer data to the client apparatus 2 of the data requesting source. The network system has the following features. That is, when data held by one of the client apparatuses 2 is requested by a different one of the client apparatuses 2, the server apparatus 1 steps in between the two client apparatuses 2 to relay data, and the control operation is performed to directly transmit/receive data between the concerned client apparatuses (the client apparatus 2 which requests the data and the client apparatus which holds the data) according to the situation.

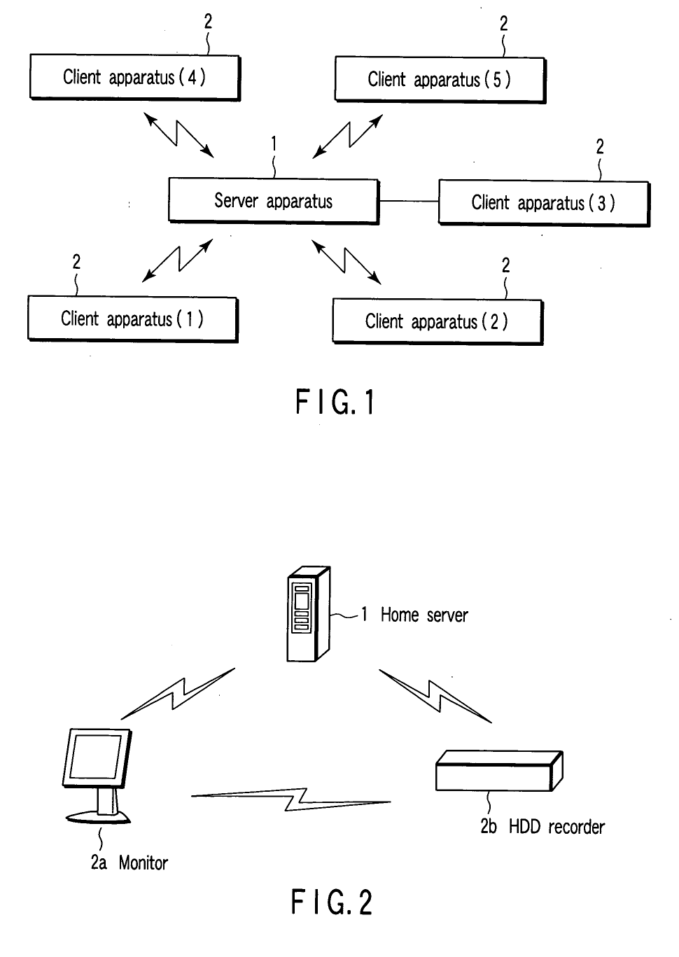

For example, as shown in FIG. 2, assume that a home server 1 is used as the server apparatus 1 and a monitor 2a and HDD recorder 2b are used as the client apparatuses 2. When the user attempts to enjoy data stored in the HDD recorder 2b on the monitor 2a, the home server 1 determines whether or not the data can be directly transmitted/received between the monitor 2a and the HDD recorder 2b. If data transmission/reception can be made, the home server 1 controls the monitor 2a and HDD recorder 2b to directly transmit/receive data between the concerned apparatuses. Further, the home server 1 monitors data transmission/reception performed between the monitor 2a and the HDD recorder 2b. When a state in which the data transmission/reception is not correctly made is detected, the home server controls the monitor 2a and HDD recorder 2b to switch the data transmission/reception of HDD recorder 2b→monitor 2a to the data transmission/reception of HDD recorder 2b→home server 1→monitor 2a.

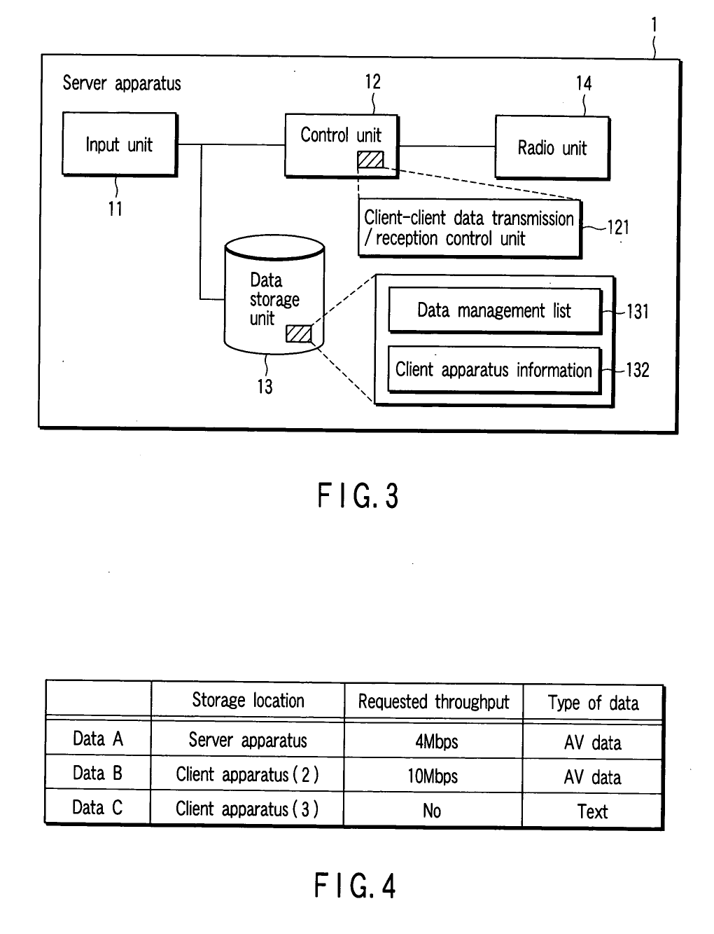

FIG. 3 is a diagram showing function blocks of the server apparatus 1. As shown in FIG. 3, the server apparatus 1 has an input unit 11, control unit 12, data storage unit 13 and radio unit 14.

The input unit 11 is used to input various information items and perform the operation of the apparatus by use of an input device such as a keyboard, a mouse, a remote controller or a touch pad. The control unit 12 controls various operations of the server apparatus 1 and has a client-client data transmission/reception control unit 121. The client-client data transmission/reception control unit 121 determines whether or not the client apparatuses 2 which are the concerned apparatuses can make direct data transmission/reception based on a throughput value of data requested by the client apparatus 2, the service condition of the radio band and the like. In this case, if the direct data transmission/reception can be made, it issues an instruction to both of the client apparatuses 2 to directly transmit/receive data.

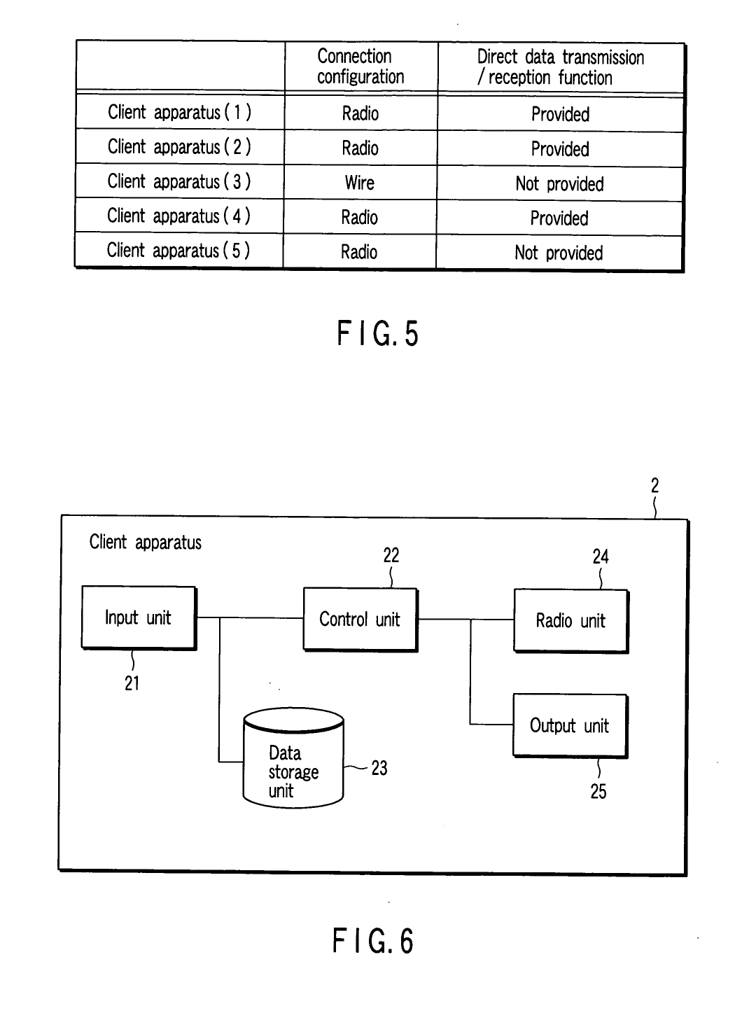

The data storage unit 13 stores various data items containing a data management list 131 and client apparatus information 132. As shown in FIG. 4, the data management list 131 is an area used to manage the storage location of each data, requested throughput and the type of data. By referring to the data management list 131, the client-client data transmission/reception control unit 121 can get information that data A is AV data which is required to have a throughput of 4 Mbps and held in the server apparatus 1, for example. Further, it can get information that data B is AV data which is required to have a throughput of 10 Mbps and held in the client apparatus (2) 2. As shown in FIG. 5, the client apparatus information 132 is an area used to manage the connection configuration of the respective client apparatuses 2 and the presence or absence of the direct data transmitting/receiving function. By referring to the client apparatus information 132, the client-client data transmission/reception control unit 121 can get information that the client apparatus (1) 2 is an apparatus which has the direct data transmitting/receiving function and makes radio connection, for example. Further, it can get information that the client apparatus (3) 2 is an apparatus which makes wire connection, and so has no direct data transmitting/receiving function. In addition, it can get information that the client apparatus (5) 2 is an apparatus which makes radio connection, but has no direct data transmitting/receiving function.

The radio unit 14 performs a data transmission/reception process using the short-range radio technology such as IEEE802.11.

FIG. 6 is a diagram showing function blocks of each of the client apparatuses 2. As shown in FIG. 6, the client apparatus 2 includes an input unit 2, control unit 22, data storage unit 23, radio unit 24 and output unit 25.

The input unit 21 is used to input various information items and perform the operation of the apparatus by use of an input device such as a keyboard, a mouse, a remote controller or a touch pad. The control unit 22 controls various operations of the client apparatuses 2. Further, it performs a direct data transmission/reception process with respect to a different client apparatus 2 based on an instruction from the server apparatus 1.

The data storage unit 23 stores various data items containing data registered in the data management list 131. The radio unit 24 performs a data transmission/reception process using the short-range radio technology such as IEEE802.11. The output unit 25 outputs received data by use of an output device such as a display or a speaker.

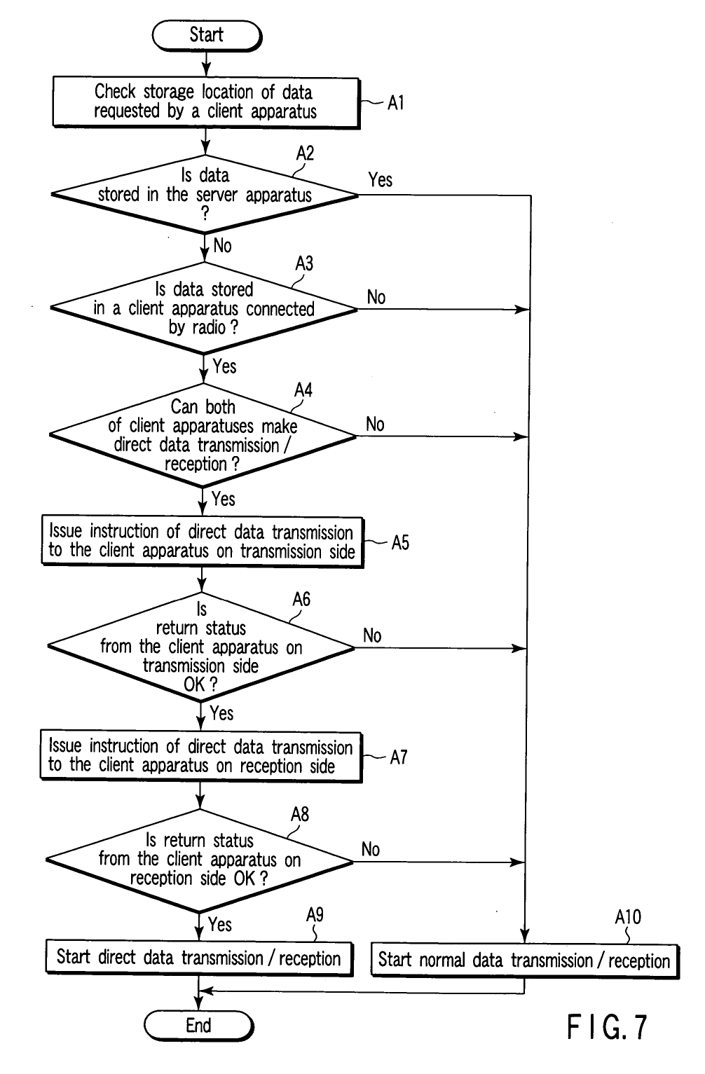

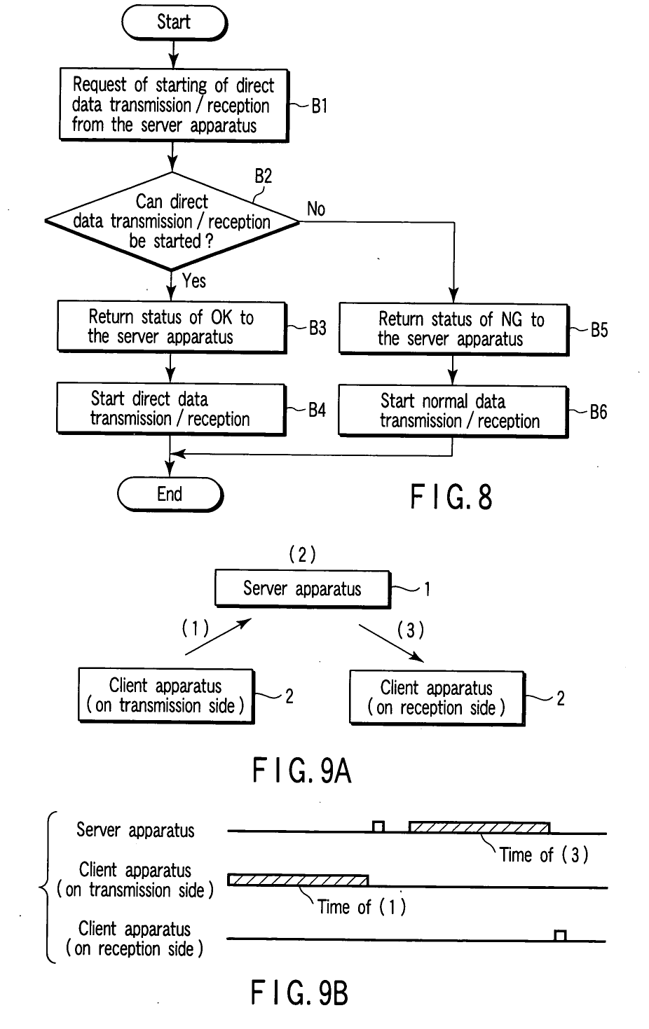

Next, the principle of the data transmission/reception operation between the client apparatuses performed in the network system is explained with reference to FIGS. 7 and 8.

FIG. 7 is a flowchart showing a flow of the process at the starting time of data transmission/reception between the client apparatuses on the server apparatus 1 side.

The server apparatus 1 first checks the location in which data requested by the client apparatus 2 is stored by referring to the data management list 131 (step A1). If the data is not stored in the server apparatus 1 (“NO” in the step A2), the server apparatus 1 checks whether or not the data is stored in the client apparatus 2 which is connected by radio (step A3).

If the data is stored in the client apparatus 2 which is connected by radio (“YES” in the step A3), the server apparatus 1 checks whether or not both of the client apparatuses 2 on the data transmission side and data reception side support the direct data transmitting/receiving function (step A4) Then, if both of the apparatuses support the function (“YES” in the step A4), the server apparatus 1 first issues an instruction to the client apparatus 2 which holds the data to perform the direct data transmission operation with respect to the client apparatus 2 which has requested the data (step A5). After issuing the instruction, the server apparatus 1 checks the return status from the client apparatus 2 which is instructed to perform the direct data transmission operation (step A6) If the return status is OK or permissible (“YES” in the step A6), the server apparatus 1 issues an instruction to the client apparatus 2 which has requested the data to receive the data by direct data reception from the client apparatus 2 which holds the data (step A7). Also, when the above instruction is issued, the server apparatus 1 checks the return status from the client apparatus 2 which is instructed to perform the direct data reception operation (step A8). If the return status is OK or permissible (“YES” in the step A8), the server apparatus 1 starts the direct data transmission/reception operation by the two client apparatuses 2 (step A9).

If one of the following cases occurs, the server apparatus 1 starts the normal data transmission/reception operation such as the data transmission/reception operation between the two client apparatuses 2 via the server apparatus or data transmission/reception operation between the server apparatus and the client apparatus 2 (step A10). That is, the cases correspond to cases wherein the data is stored in the server apparatus 1 (“YES” in the step A2), the client apparatus 2 is not the apparatus of radio connection (“NO” in the step A3), at least one of the client apparatuses 2 does not support the direct data transmitting/receiving function (“NO” in the step A4), the return status from the client apparatus 2 on the transmission side is NG or non-permissible (“NO” in the step A6), and the return status from the client apparatus 2 on the reception side is NG or non-permissible (“NO” in the step A8).

FIG. 8 is a flowchart showing a flow of the process at the starting time of data transmission/reception between the client apparatuses 2 on the client apparatus 2 side.

If the client apparatus 2 receives a request of start of direct data transmission/reception from the server apparatus 1 (step B1), the client apparatus 2 first checks whether or not it is set in a state to start the direct data transmission/reception operation (step B2). If it is set in a direct data transmission/reception permissible state (“YES” in the step B2), the client apparatus 2 returns the return status of OK to the server apparatus (step B3) and starts the direct data transmission/reception operation (step B4).

If the client apparatus is not set in the direct data transmission/reception permissible state (“NO” in the step B2), the client apparatus 2 returns the return status of NG to the server apparatus (step B5) and starts the normal data transmission/reception operation (step B6).

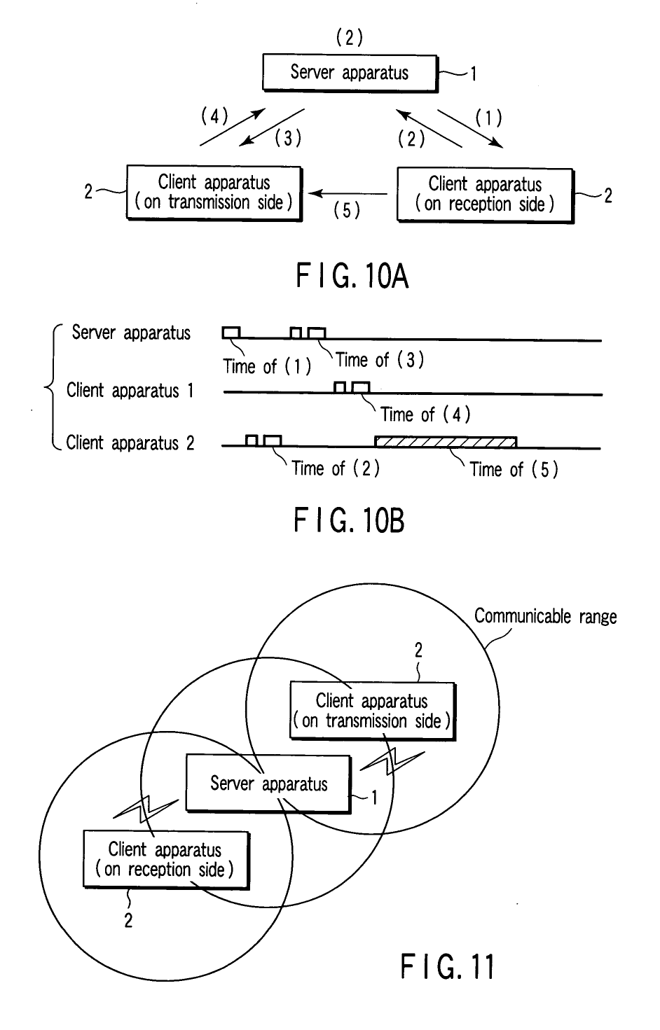

FIGS. 9A, 9B and FIGS. 10A, 10B are diagrams showing the state of normal data transmission/reception between the client apparatuses via the server apparatus which is performed by performing the above operation by use of the server apparatus 1 and client apparatus 2 and the state of direct data transmission/reception between the client apparatuses without passing through the server apparatus.

As shown in FIGS. 9A, 9B, in the case of normal data transmission/reception between the client apparatuses via the server apparatus, first, data is transmitted from the client apparatus 2 on the transmission side to the server apparatus 1 (1). Thus, the data is received by the server apparatus (2). Then, the server apparatus 1 which has received the data transmits the data to the client apparatus 2 on the reception side (3). That is, in this case, the band which is twice the radio band necessary for data transmission is used and the radio band is not efficiently utilized.

In contrast, as shown in FIGS. 10A, 10B, in the case of direct data transmission/reception between the client apparatuses without passing through the server apparatus, first, an instruction of direct data transmission is issued from the server apparatus 1 to the client apparatus 2 on the transmission side (1). Further, when the status is returned from the client apparatus 2 on the transmission side to the server apparatus 1 (2), an instruction of direct data reception is issued from the server apparatus 1 to the client apparatus 2 on the reception side (3). Then, if the status is returned from the client apparatus 2 on the reception side to the server apparatus 1 (4), the direct data transmission/reception between the client apparatuses 2 without passing through the server apparatus 1 is performed (5). In this case, since the direct data transmission/reception between the client apparatuses 2 connected to the server apparatus 1 is controlled by the server apparatus 1, the radio band can be efficiently utilized.

When the direct data transmission/reception between the client apparatuses 2 is started, a case can be considered in which the direct data transmission/reception between the two client apparatuses cannot be made depending on the positional relation of the two client apparatuses 2 which make data transmission/reception as shown in FIG. 11, for example. In such a case, for example, the direct data transmission/reception can be made by changing the position of one of the two client apparatuses 2. However, in the family, apparatuses such as a large-scale TV device and HDD recorder whose positions cannot be easily changed may be provided. Therefore, in the network system, there is provided a method for automatically switching the data transmission/reception to the normal data transmission/reception if it is determined that the direct data transmission/reception cannot be made after the direct data transmission/reception has been started.

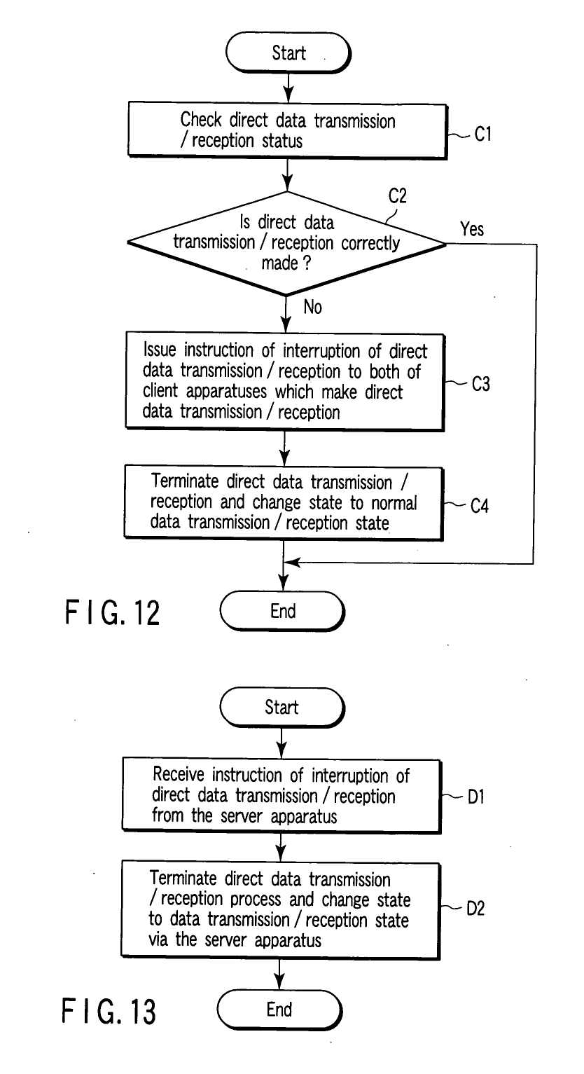

FIGS. 12, 13 are flowcharts each showing a flow of a data transmission/reception switching process. FIG. 12 shows the operation procedure on the server apparatus 1 side and FIG. 13 shows the operation procedure on the client apparatus 2 side.

While at least one set of the client apparatuses 2 are performing the direct data transmission/reception, the server apparatus 1 checks all of radio data items which the client apparatuses 2 transmit (step C1 in FIG. 12). As shown in FIG. 11, even when data cannot be transmitted/received between the two client apparatuses 2, the server apparatus 1 can detect radio data which the two client apparatuses transmit. If it is determined that data transmission/reception between any two of the client apparatuses 2 is not correctly performed (“NO” in the step C2 of FIG. 12), the server apparatus 1 issues an instruction of interruption of the direct data transmission/reception process to the two client apparatuses 2 (step C3 in FIG. 12). Then, it switches the process to the normal data transmission/reception process via the server apparatus (step C4 in FIG. 12). As the condition of determination set in the step C2, it is possible to use a method for checking a transmission data amount from the client apparatus 2 on the transmission side and a normal reception data amount in the client apparatus 2 on the reception side and determining that the communication state in the direct data transmission/reception process is bad when the normal reception data amount becomes smaller than a specified rate of the transmission data amount.

If the client apparatus 2 receives an instruction of interruption of the direct data transmission/reception process from the server apparatus 1 (step D1 in FIG. 13), it interrupts the direct data transmission/reception process and switches the process to the normal data transmission/reception process (step D2 in FIG. 13).

By the method described above, if the direct data transmission/reception process is not correctly performed according to the positional relation between the client apparatuses 2, it is possible to automatically switch the data transmission/reception method from the direct data transmission/reception method to the normal data transmission/reception method via the server apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A server apparatus comprising:
a data management unit configured to manage information associated with data held by a first client apparatus;
a device management unit configured to manage information indicating whether data can be directly transmitted/received between the first client apparatus and a second client apparatus;
a determination unit configured to determine whether data requested by the second client apparatus is held in the first client apparatus based on the information managed by the data management unit, and determine whether data can be directly transmitted/received between the first and second client apparatuses based on the information managed by the device management unit; and
a control unit configured to control the first and second client apparatuses to directly transmit/receive data when the determination unit determines that the first client apparatus holds the requested data and the data can be directly transmitted/received.

2. The server apparatus according to claim 1, further comprising a monitoring unit configured to monitor a transmission/reception state in which data is directly transmitted/received between the first and second client apparatus; and
wherein the control unit controls the first and second client apparatuses to switch the direct transmission/reception to indirect transmission/reception via the server apparatus when the monitoring unit detects a state in which transmission/reception is not correctly made.

3. The server apparatus according to claim 1, wherein the data management unit manages a throughput value requested at the transmission/reception time and the determination unit further determines whether transmission/reception which satisfies the requested throughput value can be made between the first and second client apparatuses.

4. The server apparatus according to claim 1, wherein the control unit controls the first client apparatus to receive data from the server apparatus when the determination unit determines that the data is stored in the server apparatus.

5. The server apparatus according to claim 1, wherein the device management unit manages information indicating a connection configuration of one of radio and wire, and the determination unit determines that data cannot be directly transmitted/received between the first and second client apparatuses when at least one of the first and second client apparatuses has the connection configuration of wire.

6. A network system having a comprising:
a server apparatus; and
a plurality of client apparatuses; and
the server apparatus including:
a data management unit configured to manage information associated with data held by a first client apparatus;
a device management unit configured to manage information indicating whether data can be directly transmitted/received between the first client apparatus and a second client apparatus;
a determination unit configured to determine whether data requested by the second client apparatus is held in the first client apparatus based on information managed by the data management unit, and determine whether data can be directly transmitted/received between the first and second client apparatuses based on information managed by the device management unit; and
a control unit configured to control the first and second client apparatuses to directly transmit/receive data when the determination unit determines that the first client apparatus holds the requested data and the data can be directly transmitted/received, and
each of the client apparatuses including:
a data storage unit;
a transmission/reception unit configured to directly transmit/receive data with respect to another client apparatus;
a data transmission control unit configured to transmit data stored in the data storage unit to another client apparatus by use of the transmission/reception unit in response to an instruction from the server apparatus; and
a data reception control unit configured to receive data from another client apparatus by use of the transmission/reception unit and store the data in the data storage unit in a case where a request of data transmission is issued to the sever apparatus and an instruction to the effect that the data is received from another client apparatus is issued from the server apparatus.

7. The network system according to claim 6, wherein the server apparatus further includes a monitoring unit configured to monitor a transmission/reception state in which data is directly transmitted/received between two of the client apparatuses; and
the control unit of the server apparatus control the two client apparatuses to switch the direct transmission/reception to indirect transmission/reception via the server apparatus when the monitoring unit detects a state in which the transmission/reception is not correctly made,
the data transmission control unit of each of the client apparatuses switches data transmission with respect to another client apparatus to data transmission with respect to the server apparatus in response to an instruction from the server apparatus, and
the data reception control unit of each of the client apparatuses switches data reception from another client apparatus to data reception from the server apparatus in response to an instruction from the server apparatus.

8. The network system according to claim 6, wherein the device management unit of the server apparatus manages information indicating a connection configuration of one of radio and wire for each of the client apparatuses, and the determination unit of the server apparatus determines that data cannot be directly transmitted/received between the first and second client apparatuses when at least one of the first and second client apparatuses has the connection configuration of wire.

9. The network system according to claim 6, wherein the control unit of the server apparatus controls one of the client apparatuses which has requested data to receive the data from the server apparatus when the determination unit determines that the data is stored in the server apparatus.

10. A data transmission/reception control method comprising:
managing information associated with data held by a first client apparatus, and information indicating whether data can be directly transmitted/received between the first client apparatus and a second client apparatus,
determining whether data requested by the second client apparatus is held in the first client apparatus based on the above information, and whether data can be directly transmitted/received between the first and second client apparatus based on the managed information, and
controlling the first and second client apparatuses to directly transmit/receive data when it is determined that the first client apparatus holds the requested data and the data can be directly transmitted/received.

11. The data transmission/reception control method according to claim 10, further comprising:
monitoring a transmission/reception state in which data is directly transmitted/received between the first and second client apparatuses, and
controlling the first and second client apparatuses to switch the transmission/reception to indirect transmission/reception via the server apparatus when a state in which the transmission/reception is not correctly made is detected by monitoring.
